(19) United States
(12) Patent Application Publication
(10) Pub. No.: US 2026/0274104 A1
(43) Pub. Date: Sep. 17, 2026

(54) System and Method for Increasing the Charge Rate of an Electric Vehicle in an Alternating Current Environment

(71) Applicant: Splitvolt, Inc., Santa Clara, CA (US)

(72) Inventor: Daniel Liddle, Gilroy, CA (US)

(21) Appl. No.: 19/201,614

(22) Filed: May 7, 2025

Related U.S. Application Data
(60) Provisional application No. 63/661,297, filed on Jun. 18, 2024.

(51) Int. Cl. B60L 53/62; B60L 53/67; B60L 53/68; H02J 7/90

(52) U.S. Cl. CPC B60L 53/62; B60L 53/67; B60L 53/68; H02J 7/933; H02J 7/971; B60L 2240/80

(57) ABSTRACT

A controller, for use in an alternating current environment, for controlling a charge applied to electrical devices, such as electric vehicles and plug-in hybrid electric vehicles. The controller determines the current/power to be applied to the electrical devices to decrease charging time compared to conventional techniques while satisfying charging standards.

### RELATED APPLICATION

This application claims priority to and claims the benefit of U.S. Provisional Application No. 63/661,297, filed Jun. 18, 2024, which is incorporated by reference herein in its entirety. This application is also related to U.S. patent application Ser. No. 17/841,361 filed on Jun. 15, 2022, titled Method and Apparatus for Intelligent Splitting and Controlling of a High Voltage Outlet, which is incorporated by reference herein in its entirety.

### BACKGROUND

The US National Electric Code (NEC) limits the ampacity in branch-circuit conductors.

This limit increases the time necessary to charge electrical devices, e.g., an electric vehicle (EV) which includes plug in hybrid electric vehicles (PHEV). What is needed is a system and method to reduce the time necessary to charge electrical devices while satisfying the NEC.

### BRIEF DESCRIPTION OF THE DRAWINGS

FIG. 1 is an illustration of an electric vehicle charging system according to one embodiment.

FIG. 2 is a flow chart showing the operation of an electric vehicle charging system according to one embodiment.

FIG. 3 is a table showing examples of the operation of an electric vehicle charging system according to one embodiment.

### DETAILED DESCRIPTION

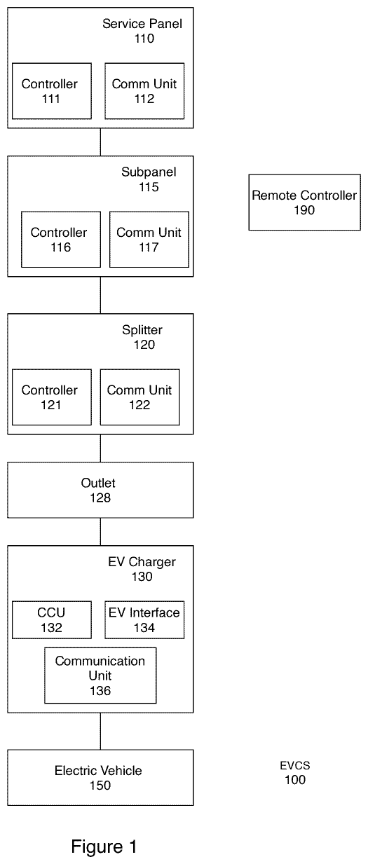

FIG. 1 is an illustration of an electric vehicle charging system (EVCS) 100 according to one embodiment. In one embodiment the EVCS 100 is in a residential dwelling although it is envisioned that the EVCS 100 can be in other locations. In this example, the EVCS 100 can include an electrical service panel 110 that can include multiple breakers and fuses, for example. In addition, the service panel 110 can optionally include a controller 111 and a communication unit 112. The optional controller 111 can control, inter alia, the amount of current traversing one or more power lines through the panel 110. The optional communication unit 112 can communicate with other devices described below, e.g., subpanel 115, splitter 120, EV charger 130, electric vehicle 150, and/or remote controller 190, for example.

An optional subpanel 115 can be positioned to receive a power cable from the service panel. In an alternate embodiment the optional subpanel 115 can be positioned to receive a power cable after the power cable traverses an optional splitter 120, described below. The subpanel 115 can optionally include a controller 116 and a communication unit 117. The optional controller 116 can control, inter alia, the amount of current traversing one or more power lines through the subpanel 115. The optional communication unit 117 can communicate with other devices described below, e.g., service panel 110, splitter 120, electric vehicle (EV) charger 130, EV 150, and/or remote Controller 190, for example.

An optional splitter 120 can be positioned to receive a power cable from subpanel 115 in an embodiment. In alternate embodiments, the subpanel 115 can receive a power cable from many devices in EVCS 100 and/or can be integrated within many devices in an EVCS 100, for example, service panel 110, subpanel 115, and/or EV charger 130. One embodiment of the splitter is described in U.S. patent application Ser. No. 17/841,361, referenced above. The splitter 120 can operate as a switch or a splitter, for example. As noted, while the splitter 120 in FIG. 1 is shown connected after the subpanel 115, this is only one example, it is envisioned that the relative positioning of the panel 110, subpanel 115 and splitter 120 can vary and other elements can be positioned between, e.g., additional subpanels 115, splitters 120 and/or other devices. The splitter 120 can optionally include a controller 121 and a communication unit 122. The optional controller 121 can control, inter alia, the amount of current traversing one or more power lines through the splitter 120. The optional communication unit 122 can communicate with other devices described below, e.g., service panel 110, subpanel 115, EV charger 130, EV 150, and/or remote Controller 190, for example.

One or more optional electrical outlet(s) 128 can be one of a variety of voltages, e.g., 120 v, 220 v, 240 v, or other voltages. Current US regulations limit the maximum current in NEMA connectors (outlets) to 60 amps (A). If a higher current is used, or even if a lower current is used, one option is to hard wire the components, e.g., the EV Charger 130 with the service panel 110, subpanel 115, and/or splitter 120, to avoid needing to plug in the EV charger 130. If there are multiple electrical outlets 128, the outlets can be used in any configuration, e.g., serial, daisy-chain, parallel, including any combination thereof. In embodiments, an alternating current (AC) is used.

EVCS 100 includes an EV charger 130 that includes an EV interface 134 to connect with an electric vehicle 150 (EV). The EV charger 130 includes a charging control unit (CCU) 132 and a communication unit 136. The optional CCU 132 can control, inter alia, the amount of current traversing through the EV interface 134 to charge the EV 150. The optional communication unit 136 can communicate with other devices, e.g., service panel 110, subpanel 115, splitter 120, EV 150, and/or Remote Controller 190, for example.

Optional remote controller 190 is capable of communication with one or more of service panel 110, subpanel 115, splitter 120, EV charger 130, and/or EV 150, for example. Remote controller 190 typically includes a processor, memory, storage, and software/firmware. Examples of a remote controller 190 include a smart phone application, a computer, a cloud computing environment, etc.

In embodiments, the system can charge multiple EVs 150. The control of the charging power/current is described herein and be performed by any of the controllers.

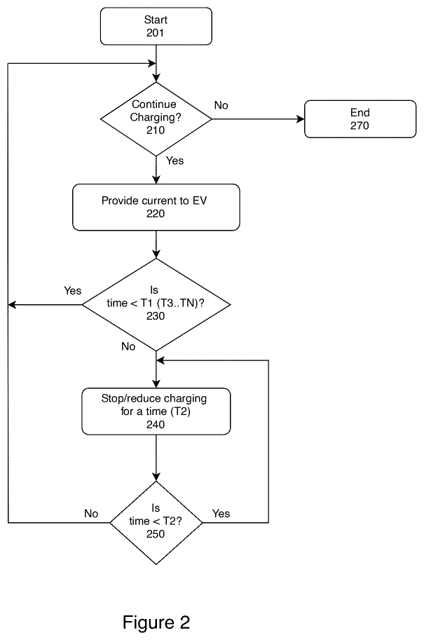

FIG. 2 is a flow chart showing the operation of an electric vehicle charging system according to one embodiment. The operations in FIG. 2 can be performed by one or more controllers, e.g., controller 111, controller 116, controller 121, CCU 132, a controller in the EV 150, and/or remote controller 190, for example.

The US National Electric Code (NEC) article 210 sets forth various requirements for wiring and protection for branch circuits. The NEC is incorporated by reference herein in its entirety.

One summary of NEC 210.20(A) is that it requires that a standard rated (80%) breaker can only be applied continuously at 80% of its continuous current rating (iₘₐₓ). Continuously is defined as continuous operation for 3 or more hours according to the NEC. It is envisioned that other definitions of the time to be considered continuous can be used, e.g., by other standards or a change to the NEC standards. For example, a home power outlet can be 240V/30 A, or 220V/30 A, for example. Often this is voltage/power level is provided to a clothes dryer but can be used for other devices, e.g., an electric vehicle. The NEC rule requires that if there will be a continuous load for 3 or more hours than the maximum current allowed is 80% of 30 A, i.e., 24 A.

This NEC rule is referred to as the “80% rule” and/or “125%” rule. 80% is the reciprocal of 125% so it is the same rule, it just depends on which direction is being considered, e.g., sizing of an OCPD (overcurrent protective device) from the current, or selecting maximum ampacity from a given OCPD, for example. Herein, for ease of discussion, this will be referenced as the 80 percent rule. The 80 percent rule limits the speed at which an electric vehicle is charged.

One embodiment uses one or more controllers to intelligently apply current to an EV 150 to enable more efficient charging of the EV 150. The efficiency can result in a faster charge, and/or a less expensive charge, for example, depending upon the charging goals. For example, by limiting the continuous charging to under three hours, embodiments herein can charge using a current above the 80% rating. Similarly, embodiments can charge for just under three hours (or less) at the maximum rated current and then reduce the applied current for a period of time in order to satisfy the NEC 80 percent rule. The examples used herein are based on the current (2024) NEC standards. It is envisioned that different power/current/voltage values can be used if the NEC regulations change without departing from the scope herein.

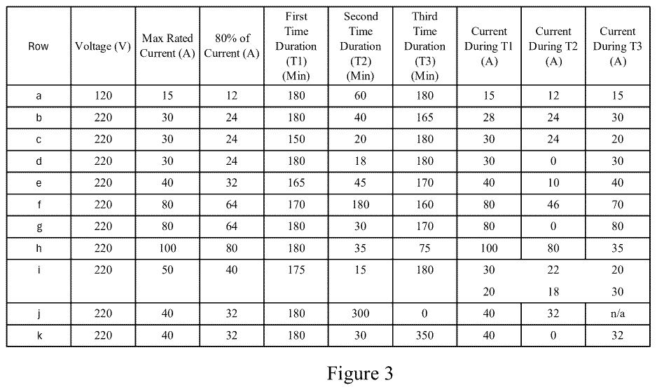

With reference to FIG. 2 and FIG. 3, when an EV 150 is to be charged 201, the system determines whether 210 the charging should continue. If not, the charging ends 270. If so, the EV Charger 130 provides/applies 220 power (current) to the EV 150. A first time duration, T1, is determined or identified. In embodiments, T1 (as well as T2, T3 . . . TN) can be predetermined, determined at the moment, be a set (fixed) time, and/or can vary during the time duration.

For ease of discussion the controllers will be referred to controller 121 herein, although, as described above, any one or combination of controllers can perform the operations in FIG. 2. In the examples set forth herein, odd numbered time durations (T1, T3 . . . TN-1) are the periods where current that exceeds 80% can be applied and even numbered time durations (T2, T4 . . . TN) are the periods where applied current is at or less than 80%. This demarcation is for ease of reference only.

The controller determines 230 whether the current time is less than time T1. If 230 the current time is less than T1 then then the process continues with step 210. In alternate embodiments, step 210 need not be affirmatively performed every time the current time is less than T1 (or T2 . . . TN), instead the process can continue providing 220 current to the EV 150.

If 230 the current time is not less than T1 then the controller instructs the device, e.g., EV Charger 130, to stop/reduce charging 240 the EV 150 for a second time duration T2. In embodiments, the EV Charger 130 stops 240 providing power/current to the EV 150 for time duration T2. In other embodiments the EV Charger 130 modifies 240 the amount of power/current provided to the EV 150. If 250 the current time is less than T2 then the stopping/reduced charging 240 continues. When the current time is not less than T2 then the process continues with step 210 and if the charging continues 210, the EV Charger provides 220 current (power) to the EV 150 for a third time duration (T3). In this example, the current provided during T3 need not be equal to the current provided in any other time period, although in some embodiments it can be equal.

A similar way to envision, is by applying 220 a charging load (charge) during a period of time, e.g., T1, followed by a significant, documentable/identifiable break (time T2) 240 in the application of a charge (current), T2. A new charging load can be applied 220 during a third period of time, e.g., T3. In some embodiments, a user can select to charge 220 an EV using a current above 80% of iₘₐₓ for a time (T1) such as approximately three hours. Immediately following the first time (T1), the charging stops 240 for a second period of time (T2) which may be deemed a significant period of time. Thereafter, a new charging load is applied (possibly providing a top-off charge on the same EV or a different EV/device) 220 during a third period (T3). The charge/charging load applied during T3 can be any value below ᵢₘₐₓ. If the current applied during T3 is above 80% of iₘₐₓ then, in these embodiments, the third period of time (T3) is no more than the definition of continuous time as defined by a standard, e.g., 3 hours according to the current NEC standard. In embodiments, a significant period of time is at least ten percent of the total expected time load (ten percent of time T1) or ten percent of the continuous time period, e.g., 18 minutes. In embodiments, a user can identify/select/determine charging options such that the user's option is selected prior to the start of a first time period and the selected charging option includes the operation during time periods T1, T2 and T3, that is, the application of said third current value or additional charging load does not require user intervention during any of said first, second, and third time periods.

While FIG. 2 shows the operation with reference to two time durations (T1 and T2), the process continues with additional time durations, e.g., T3, T4 . . . TN, which may or may not be equal to any other time durations. FIG. 3 is a table showing examples of the operation of an electric vehicle charging system according to one embodiment. FIG. 3, row (a) shows an example system where the circuit has an applied voltage of 120V and a maximum rated current of 15 A, which correlates with an 80% current of 12 A. In contrast to conventional systems which provide a maximum of 12 A (80 %) throughout the time that the EV 150 is charging, the embodiments herein apply/provide 220 a current that exceeds the 80% current. In this example, a current of 15 A is provided for a duration of (just under) 180 minutes (T1). When (step 250) the current time is equal to or greater than T1 (180 minutes), the current is reduced to 12 A for a period of 60 minutes (T2). When the current time is equal to or exceeds T2 (60 minutes since T1 ended, which is 240 minutes after the charging first started (T1+T2)) then the process continues by determining whether 210 charging should continue and in this case it does continue providing (step 220) current for another 180 minutes (T3) at 15 A.

In the example shown in FIG. 3, row (b), a circuit has an applied voltage of 220V and a maximum rated current of 30 A, which correlates with an 80% current of 24 A. In this example, a current of 28 A is provided for a duration of (just under) 180 minutes (T1). When (step 250) the current time is equal to or greater than T1 (180 minutes), the current is reduced to 24 A for a period of 45 minutes (T2). When the current time is equal to or exceeds T2 (40 minutes since T1 ended, which is 220 minutes after the charging first started (T1+T2)) then the process continues by determining whether 210 charging should continue and in this case it does continue providing (step 220) current for 165 minutes (T3) at 30 A. In embodiments, the current applied during a period can be an average current applied during that period. For example, using the situation described in FIG. 3, row (b), where T1 is 180 min, and the current during T1 is 28 A. This includes the situation where 30 A are applied for the first 90 minutes of T1 and 26 A are applied for the second 90 minutes of T1 and, therefore, the average current during T1 is 28 A.

In the example shown in FIG. 3, row (c), a circuit has an applied voltage of 220V and a maximum rated current of 30 A, which correlates with an 80% current of 24 A. In this example, a current of 30 A is provided for a duration of (just under) 150 minutes (T1). When (step 250) the current time is equal to or greater than T1 the current is reduced to 24 A for a period of 20 minutes (T2). When the current time is equal to or exceeds T2 (20 minutes since T1 ended, which is 170 minutes after the charging first started (T1+T2)) then the process continues by determining whether 210 charging should continue and in this case it does continue providing (step 220) current for 180 minutes (T3) at 20 A.

In the example shown in FIG. 3, row (d), a circuit has an applied voltage of 220V and a maximum rated current of 30 A, which correlates with an 80% current of 24 A. In this example, a current of 30 A is provided for a duration of (just under) 180 minutes (T1). When (step 250) the current time is equal to or greater than T1 no current is provided (the current is reduced to 0 A) for a period of 18 minutes (T2). In embodiments, this is a minimum time in order to be a significant break before applying a new load. When the current time is equal to or exceeds T2 (18 minutes since T1 ended, which is 198 minutes after the charging first started (T1+T2)) then the process continues by determining whether 210 a new charging load should begin and in this case it does and provides (step 220) current for 180 minutes (T3) at 30 A. In embodiments, a user may instruct the ECVS 100 to charge the electrical device, e.g., an EV, using a single instruction to provide a first load charge during T1, followed by a charging delay during T2 where the current is effectively zero amps (“effectively zero” is any value less than a de minimus current that is a negligible impact on charging time or energy consumption, e.g., 0.5 amps), followed by another load charge (current) during T2. That is, once charging begins during the first time period, the user does not need provide additional instructions during any of time periods T1, T2, and T3. In embodiments, charging periods, e.g., T1, T3 . . . , are considered new, unique and separate charging loads.

In the example shown in FIG. 3, row (e), a circuit has an applied voltage of 220V and a maximum rated current of 40 A, which correlates with an 80% current of 32 A. In this example, a current of 40 A is provided for a duration of (just under) 165 minutes (T1). When (step 250) the current time is equal to or greater than T1 the current is reduced to 32 A for a period of 45 minutes (T2). When the current time is equal to or exceeds T2 (45 minutes since T1 ended, which is 210 minutes after the charging first started (T1+T2)) then the process continues by determining whether 210 charging should continue and in this case it does continue providing (step 220) current for 170 minutes (T3) at 40 A.

In the example shown in FIG. 3, row (f), a circuit has an applied voltage of 220V and a maximum rated current of 80 A, which correlates with an 80% current of 64 A. In this example, a current of 80 A is provided for a duration of (just under) 170 minutes (T1). When (step 250) the current time is equal to or greater than T1 the current is reduced to 46 A for a period of 180 minutes (T2). In this example, 46 A is the maximum current that can be applied while allowing the average current during the first two periods (T1+T2) to be at or less than 80% of iₘₐₓ. This may be a requirement in some standards. In embodiments, this average of the first two period feature will be used. When the current time is equal to or exceeds T2 (180 minutes since T1 ended, which is 350 minutes after the charging first started (T1+T2)) then the process continues by determining whether 210 charging should continue and in this case it does continue providing (step 220) current for 160 minutes (T3) at 70 A.

In the example shown in FIG. 3, row (g), a circuit has an applied voltage of 220V and a maximum rated current of 80 A, which correlates with an 80% current of 64 A. In this example, a current of 80 A is provided for a duration of (just under) 180 minutes (T1). When (step 250) the current time is equal to or greater than T1, no current is provided (the current is reduced to 0 A) for a period of 30 minutes (T2). When the current time is equal to or exceeds T2 (30 minutes since T1 ended, which is 210 minutes after the charging first started (T1+T2)) then the process continues by determining whether 210 a new charging load should begin and in this case it does and provides (step 220) current for 170 minutes (T3) at 80 A.

In the example shown in FIG. 3, row (h), a circuit has an applied voltage of 220V and a maximum rated current of 100 A, which correlates with an 80% current of 80 A. In this example, a current of 100 A is provided for a duration of (just under) 180 minutes (T1). When (step 250) the current time is equal to or greater than T1 the current is reduced to 80 A for a period of 35 minutes (T2). When the current time is equal to or exceeds T2 (35 minutes since T1 ended, which is 215 minutes after the charging first started (T1+T2)) then the process continues by determining whether 210 charging should continue and in this case it does continue providing (step 220) current for 75 minutes (T3) at 35 A.

In the example shown in FIG. 3, row (i), a circuit has an applied voltage of 220V and a maximum rated current of 50 A, which correlates with an 80% current of 40 A. As described above, any number of EVs 150 can be charged simultaneous. In this example, two EVs 150 are being charged. The 80 percent rule applies to the entire circuit, subpanel, etc. so the sum of the currents of all charging EVs 150 must be accounted for. In this example, a total current of 50 A is provided for a duration of (just under) 175 minutes (T1). 30 A are provide to a first EV and 20 A are applied to a second EV 150. When (step 250) the current time is equal to or greater than T1 the current is reduced to 40 A for a period of 15 minutes (T2). 22 A are provided to the first EV and 18 A are provided to the second EV (to keep the total current at or below the 80% current requirement). When the current time is equal to or exceeds T2 (15 minutes since T1 ended, which is 190 minutes after the charging first started (T1+T2)) then the process continues by determining whether 210 charging should continue and in this case it does continue providing (step 220) current for 180 minutes (T3) at 50 A. In this example, 20 A are provided to the first EV and 30 A are provided to the second EV.

In the example shown in FIG. 3, row (k), a circuit has an applied voltage of 220V and a maximum rated current of 40 A, which correlates with an 80% current of 32 A. In this example, a current of 40 A is provided for a duration of (just under) 180 minutes (T1). When (step 250) the current time is equal to or greater than T1, no current is provided (the current is reduced to 0 A or is below a minimum current that is considered ending the charging load if such a minimum is required by a standard) for a period of 30 minutes (T2). When the current time is equal to or exceeds T2 (30 minutes since T1 ended, which is 210 minutes after the charging first started (T1+T2)) then the process continues by determining whether 210 a new charging load should begin and in this case it does and provides (step 220) current for 350 minutes (T3) at 32 A. T3 can exceed the time defined as continuous time (as described above) because the current applied during T3 is at or below 80% of iₘₐₓ.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment. Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

The embodiments also relate to an apparatus for performing the operations herein. This apparatus may be specially constructed for the purposes, e.g., a specific computer, or it may comprise a computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

Throughout this specification, some embodiments have used the expression “coupled” along with its derivatives. The term “coupled” as used herein is not necessarily limited to two or more elements being in direct physical or electrical contact. Rather, the term “coupled” may also encompass two or more elements are not in direct contact with each other, but yet still co-operate or interact with each other, or are structured to provide a thermal conduction path between the elements.

Likewise, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of embodiments. This description should be read to include one or at least one and the singular also includes the plural unless it is obvious that it is meant otherwise. The use of the term and/or is intended to mean any of: “both”, “and”, or “or.”

In addition, the language used in the specification has been principally selected for readability and instructional purposes and may not have been selected to delineate or circumscribe the inventive subject matter. Accordingly, the disclosure of the embodiments is intended to be illustrative, but not limiting, of the scope of the embodiments.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments.

What is claimed is:

1. A method for controlling alternating charging currents applied to an electrical device comprising the steps of:
determining a first time period;
determining a first current value representing a first of the alternating charging currents applied during said first time period;
identifying a maximum permitted continuous current value representing a first percentage of a maximum current rating;
wherein said first current value exceeds said maximum permitted continuous current value;
determining a second time period, occurring immediately after said first time period;
determining a second current value representing a second of the alternating charging currents applied during said second time period;
wherein said second current value is less than said maximum permitted continuous current value and is greater than zero amps; and
wherein a first combined time duration exceeds a maximum continuous time period, wherein said first combined time duration is equal to a sum of said first and second time periods.

2. The method of claim 1, wherein said maximum continuous time period is a maximum continuous duration permitted for a maximum rated current to be applied as forth by a standard.

3. The method of claim 1, wherein said maximum current rating is based on one of a breaker or fuse.

4. The method of claim 1, wherein the first percentage is set forth in a standard.

5. The method of claim 1, wherein the electrical device is at least one of an electric vehicle or a plug-in hybrid electric vehicle.

6. The method of claim 1, wherein said first current value is an average of the alternating charging currents applied during the first time period.

7. The method of claim 1, wherein said first current value is the sum of the alternating charging currents applied to two or more electrical devices during said first time period, and wherein said second current value is the sum of the alternating charging currents applied to two or more electrical devices during said second time period.

8. The method of claim 1, wherein said first time period can be one or more of predetermined, determined at the moment, be a fixed time, or variable during said first time period.

9. The method of claim 1, further comprising the steps of:
determining a third time period;
determining a third current value representing a third of the alternating charging currents applied during said third time period;
wherein said third current value exceeds said maximum permitted continuous current value;
determining a fourth time period, occurring immediately after said third time period;
determining a fourth current value representing a fourth of the alternating charging currents applied during said fourth time period;
wherein said fourth current value is less than said maximum permitted continuous current value and is greater than zero amps; and
wherein a second combined time duration exceeds a maximum continuous time period, wherein said second combined time duration is equal to a sum of said third and fourth time periods.

10. A method for controlling alternating charging currents applied to an electrical device comprising the steps of:
determining a first time period;
determining a first current value representing a first of the alternating charging currents applied during said first time period;
identifying a maximum permitted continuous current value representing a first percentage of a maximum current rating;
wherein said first current value exceeds said maximum permitted continuous current value;
determining a second time period, occurring immediately after said first time period;
determining a second current value representing a second of the alternating charging currents applied during said second time period;
wherein said second current value is effectively zero amps;
wherein said second time period is a duration that is between fifteen percent and one hundred percent of said first time period;
wherein a first combined time duration exceeds a maximum continuous time period, wherein said first combined time duration is equal to a sum of said first and second time periods;
determining a third time period occurring immediately after said second time period; and
determining a third current value representing a third of the alternating charging currents applied during said third time period;
wherein the application of said third current value does not require user intervention during any of said first, second, and third time periods.

11. The method of claim 10, wherein said third current value exceeds said maximum permitted continuous current value.

12. The method of claim 10, wherein said maximum continuous time period is a maximum continuous duration permitted for a maximum rated current to be applied as forth by a standard.

13. The method of claim 10, wherein said maximum current rating is based on one of a breaker or fuse.

14. The method of claim 10, wherein said first current value is an average of the alternating charging currents applied during said first time period.

15. The method of claim 10, wherein said first current value is the sum of the alternating charging currents applied to two or more electrical devices during said first time period, and wherein said third current value is the sum of the alternating charging currents applied to two or more electrical devices during said third time period.

16. A controller comprising capable of controlling alternating charging currents applied to an electrical device, the controller having:
a time period determinator to determine a first time period and a second time period, said second time period occurring immediately after said first time period;
a current value determinator to determine a first current value representing a first of the alternating charging currents applied during said first time period, and to determine a second current value representing a second of the alternating charging currents applied during said second time period; and
a maximum continuous current value determinator to identify a maximum permitted continuous current value representing a first percentage of a maximum current rating;
wherein said first current value exceeds said maximum permitted continuous current value;
wherein said second current value is less than said maximum permitted continuous current value and is greater than zero amps; and
wherein a first combined time duration exceeds a maximum continuous time period, wherein said first combined time duration is equal to a sum of said first and second time periods.

17. The controller of claim 16, wherein said maximum continuous time period is a maximum continuous duration permitted for a maximum rated current to be applied as forth by a standard.

18. The controller of claim 16, wherein said time period determinator, said current value determinator, and said maximum continuous current value determinator are in two or more devices.

19. The controller of claim 16, wherein said first current value is an average of the alternating charging currents applied during the first time period, and wherein said second current value is an average of the alternating charging currents applied during the second time period.

20. The controller of claim 16, wherein said first current value is the sum of the alternating charging currents applied to two or more electrical devices during said first time period, and wherein said second current value is the sum of the alternating charging currents applied to two or more electrical devices during said second time period.
